(19) United States
(12) Patent Application Publication
(10) Pub. No.: US 2010/0234510 A1
(43) Pub. Date: Sep. 16, 2010

(54) TIN-FREE SINGLE-COMPONENT SILICONE COMPOSITIONS CROSSLINKABLE INTO ELASTOMERIC STATE

(76) Inventors: Michel Feder, Villeurbanne (FR); Hervé Parisot, Caluire (FR); Nathalie Guennouni, Irigny (FR)

Correspondence Address: BUCHANAN, INGERSOLL & ROONEY PC, POST OFFICE BOX 1404, ALEXANDRIA, VA, 22313-1404, US

(21) Appl. No.: 12/514,243

(22) PCT Filed: Nov. 9, 2007
(86) PCT No.: PCT/EP2007/062165

§ 371 Date: Jun. 2, 2010

(30) Foreign Application Priority Data
Nov. 9, 2006 (FR) 0609785

(51) Int. Cl. C08L 83/04; C08K 3/36; C08K 3/04; C08K 3/22; C08K 3/26; C08K 3/30

(52) U.S. Cl. 524/423; 524/588; 524/442; 524/430; 524/425; 524/432; 524/449; 524/451; 524/431; 525/474

(57) ABSTRACT

Tin-free, single-component silicone compositions which are stable with respect to storage in the absence of moisture, and which can be crosslinked into an elastomer by means of polycondensation reactions at ambient temperature and in the presence of water; such elastomers are adherent on various supports and harden rapidly and the silicone compositions contain an alkoxy-functional polyorganosiloxane (POS), a carboxylic acid and/or a carboxylic acid anhydride, and, optionally, a mineral filler of fumed silica type, an alkoxy-functional POS resin and an organometallic compound (containing no tin).

### FIELD OF THE INVENTION

The field of the invention is that of single-component silicone compositions that are stable during storage in the absence of moisture and that can be crosslinked to give silicone elastomers via polycondensation reactions at ambient temperature and in the presence of water. In particular, the silicone compositions in question are tin-free.

### TECHNICAL CONTEXT

Single-component silicone coatings, sealants and cold adhesives are generally obtained by hydrolysis/condensation from methoxy-, ketiminoxy- or acetoxy-functional silicone oils, during application, by contact with atmospheric moisture.

For example, patent application FR 2 557 582 A1 describes single-component compositions that can be crosslinked to give an elastomer that contain a catalyst based on a tin chelate, for example, dibutyltin bis(acetylacetonate).

French patent application FR 2 638 752 A1 furthermore describes a process for functionalizing an α,ω-dihydroxypolydimethylsiloxane oil by reaction with a polyalkoxysilane, in the presence of a functionalization catalyst, lithium hydroxide. The functionalized oils obtained are used for preparing compositions that can be crosslinked by condensation in the presence of water, comprising as a condensation catalyst, a tin-based organometallic compound.

The process described in application FR 2 638 752 A1 comprises the use of methyltrimethoxysilane, vinyl-trimethoxysilane or methylvinyldimethoxysilane, compounds that have the drawback of causing methanol to be released during the crosslinking by condensation.

French patent application FR 2 856 694 A1 itself describes single-component silicone compositions that crosslink at low temperature in the presence of water. The condensation reactions are catalyzed using a mixed catalyst which consists of the combination of an organic derivative of a metal (titanium, zirconium) and of an organic derivative of another metal (zinc, aluminum, boron, bismuth).

These formulations have the drawback of releasing, while they are setting, toxic or foul-smelling volatile products. Moreover, some of these products also contain catalysts based on reputedly ecotoxic tin salts.

Alternatives that make it possible to obtain products that are more pleasant to use are known. But these alternatives are not completely satisfactory to date.

Firstly it is possible to formulate elastomers in an aqueous dispersion. These formulations only release water when they set, but they inevitably contain surfactants, which are harmful to the adhesion. Moreover, they generally contain tin salts.

The formulation of silicone elastomers from ethoxy-functional silicone oils can also be envisaged, but these formulations pose the two-fold problem of:
achieving a sufficiently rapid functionalization of the silicone oils via the crosslinker, an ethoxy-functional silane, in order to be compatible with industrial productivity constraints; and
obtaining a sufficiently reactive composition, capable of curing rapidly during application, under the effect of moisture from the air, especially when it is desired to avoid using tin-based catalysts.

### BRIEF DESCRIPTION OF THE INVENTION

In this context, one objective of the invention is to provide tin-free single-component silicone compositions that are very reactive despite the absence of tin catalysts. The term “reactivity” is understood to mean the formation of a chemical network that is expressed by the increase in the hardness of the elastomer formed.

It is also desirable to obtain a composition, the rapid setting of which does not interfere with a good adhesion to numerous supports. For example, it is desirable that the waiting time of the elastomer composition be as short as possible, both from the point of view of the crosslinking in the bulk (stability of the elastomer obtained) and from the point of the view of the crosslinking at the surface (elimination of the tacky feel of the surface).

Another objective of the invention is to provide a single-component silicone composition for mass-market usage, that is to say that its use is not accompanied by the emission of products considered to be toxic, irritant or simply foul-smelling. In this context, it is desirable that use of such a silicone composition be particularly easy and rapid.

Thus, one objective of the invention is to lead to a satisfactory compromise, both from the point of view of the reactivity of the silicone composition in the presence of moisture, and from the point of view of the stability during storage or the innocuousness of the silicone composition.

The invention firstly relates to a tin-free, single-component silicone composition that is stable during storage in the absence of moisture and that is capable, in the presence of water, of crosslinking by polycondensation to give an elastomer, preferably an adhesive elastomer. The composition comprises at least one crosslinkable alkoxy-functional polyorganosiloxane (POS) oil A, and as a crosslinking catalyst C, at least one carboxylic acid and/or at least one carboxylic anhydride. Moreover, the composition may comprise one or several of the following optional components:
at least one mineral filler B;
as crosslinking co-catalyst D, at least one organometallic compound in which the metal is other than tin;
at least one crosslinkable alkoxy-functional polyorganosiloxane resin E;
a residual amount of a functionalization catalyst F used during the preparation of the oil A and/or the resin E;
at least one alkoxy-functional silane and/or at least one alkylpolysilicate G;
at least one polydiorganosiloxane H that is inert with respect to the polycondensation reaction; and
at least one auxiliary agent I.

Among the silicone compositions of interest, mention may especially be made of silicone sealants comprising, in addition to at least one crosslinkable alkoxy-functional polyorganosiloxane (POS) oil A and a crosslinking catalyst C, at least one mineral filler B and, preferably, at least one crosslinkable alkoxy-functional polyorganosiloxane resin E. A silicone sealant may, like a silicone composition, comprise other optional components among those listed above.

Secondly, the invention relates to a tin-free silicone elastomer obtained by crosslinking and curing of a tin-free single component silicone composition according to the invention. Such silicone elastomers find their application in numerous industrial fields. Among these applications, mention may be made, for example, of the preparation of coatings for paints, for anti-fouling and for anti-adhesion in the food industry, formulation of waterproofing agents or of thick seals such as cold adhesives and the sealants used, in particular, in construction, the electrical goods industry or the automobile industry, and also coatings on textile supports.

The single-component silicone composition described here has all the advantageous properties that are specific to this type of product and moreover has the following advantages:
it has setting kinetics very close to that of a composition comprising a tin-based catalyst;
the tacky feel of the surface of the elastomer obtained from this composition is reduced or eliminated in the first phase following the crosslinking;
no tin is introduced;
no toxic, irritant or foul-smelling products are generated during crosslinking (acetic acid, methanol); and
elastomers are formulated that are provided with a good stability/reactivity compromise.

Moreover, the silicone composition is economical and results in crosslinked elastomers endowed with advantageous mechanical properties. The elastomers obtained adhere to numerous supports.

### DETAILED DESCRIPTION OF THE INVENTION

In the rest of the present application, the polyorganosiloxane oils and resins will be described in a conventional manner using the following common notations, used to denote various siloxy units of formula M, D, T and Q below:

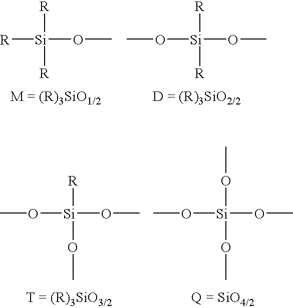

In these formulae, R may represent various hydrocarbon-based groups that are saturated or unsaturated, in particular aromatic, and optionally substituted by heteroatoms, and also groups that are not hydrocarbon-based. The meaning of R will be indicated in the description.

Conventionally, in this notation, the oxygen atoms are shared between two silicon atoms. Conventionally, one particular R group is indicated by citing it as a superscript after the symbol M, D or T. For example, M^{OH} represents an M unit where an R group is a —OH hydroxyl group. Similarly, D^{Phe2} represents a D unit for which the two R groups are —C₆H₅ phenyl groups (abbreviated to Phe). T^{Ome} represents a T unit for which the R group is a —OCH₃ methoxy group (where Me stands for methyl).

The expression “substantially linear” should be understood to mean a POS oil composed of D siloxy units comprising in addition, T siloxy units and/or Q siloxy units, the number of T and Q siloxy units being less than or equal to one per hundred of silicon atoms.

In the present text, except where indicated otherwise, the use of the singular should not be interpreted in a restrictive manner as meaning “a single” or “the sole”.

The crosslinkable alkoxy-functional polyorganosiloxane oil A (POS oil A) may be linear or substantially linear. It may also be a mixture of several silicon oils. Preferably, the POS oil A comprises a linear silicone oil of the following general formula (I):

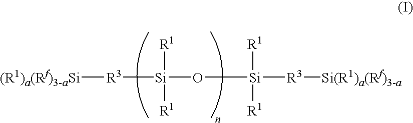

where:
the R¹ groups are identical to or different from one another and each represent a saturated or unsaturated, substituted or unsubstituted, aliphatic, cyclanic or aromatic monovalent hydrocarbon-based group comprising from 1 to 13 carbon atoms;
the R^{f} groups are identical to or different from one another and each represent a group of formula R²O—(CH₂CH₂O)_{b}— in which the R² groups are identical to or different from one another and each represent a linear or branched alkyl comprising from 1 to 8 carbon atoms, or a cycloalkyl comprising from 3 to 8 carbon atoms, and in which b is equal to 0 or 1;
the R³ groups are identical to or different from one another and each represent an oxygen atom or an aliphatic saturated divalent hydrocarbon-based group comprising from 1 to 4 carbon atoms;
the value n is sufficient to give the POS oil A a dynamic viscosity at 25° C. that ranges from 10³ mPa·s to 10⁶ mPa·s; and
a is equal to 0 or 1.

In the case where the POS oil A comprises a substantially linear silicone oil, the latter also corresponds to the general formula (I) in which siloxy units D of formula (R¹)₂SiO_{2/2} are replaced by siloxy units T of formula R¹SiO_{3/2} and/or siloxy units Q of formula SiO_{4/2}, the number of T and Q siloxy units being less than or equal to 1 per 100 silicon atoms.

The silicone composition corresponds to an embodiment form in which an essential constituent, namely the POS oil A is at least partly functionalized at its ends by one or other of the following methods:
when R³ represents an oxygen atom: by carrying out a condensation reaction between the ≡Si—OH units of a hydroxylated POS precursor A′, and an alkoxy group of an alkoxysilane, in the presence of a functionalization catalyst F; or
when R³ represents a divalent hydrocarbon-based group: by carrying out an addition reaction between the ≡Si—H units of a hydrogenated POS precursor A″, and an olefin group of an olefinic alkoxysilane, or alternatively by carrying out an addition reaction between an olefin group of an olefinic POS precursor A′″ and a hydrogen group of a hydrogenalkoxysilane.

The POS oil A is functionalized according to techniques known to a person skilled in the art. The functionalized POS oil A corresponds to a form, which is stable in the absence of moisture, of the single-component silicone composition, or of the single-component silicone sealant in question here. In practice, this stable form is that of the composition packaged in hermetically sealed cartridges, which will be opened by the operator during use and which will enable him to apply the composition or the sealant to any desired supports. Crosslinking takes place in the presence of water, in particular moisture from the air.

A hydroxylated precursor A′ of the POS oil A having alkoxy-functional chain ends is an α,ω-hydroxy polydiorganosiloxane of formula (I′)

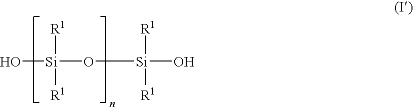

with R¹ and n being as defined above in the formula (I).

A hydrogenated precursor A″ of the POS oil A having alkoxy-functional chain ends is an α,ω-hydrogenpolydiorganosiloxane of formula (I″):

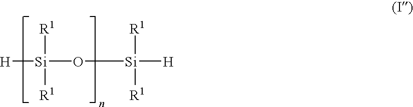

with R¹ and n being as defined above in the formula (I).

A precursor A′″ of the POS oil A having alkoxy-functional chain ends is a polydiorganosiloxane corresponding to the definition given above for A″ except that the terminal hydrogen atoms are replaced by unsaturated olefinic groups.

As has also been indicated, the silicone composition may comprise a crosslinkable alkoxy-functional poly-organosiloxane resin E (POS resin E). This resin has at least two different siloxy units chosen from the siloxy units M of formula (R¹)₃SiO_{1/2}, the siloxy units D of formula (R¹)₂SiO_{2/2}, the siloxy units T of formula R¹SiO_{3/2} and the siloxy units Q of formula SiO_{4/2}, at least one of these siloxy units being a T or Q unit, where:

the R¹ groups are identical to or different from one another and each represent a saturated or unsaturated, substituted or unsubstituted, aliphatic, cyclanic or aromatic monovalent hydrocarbon-based group comprising from 1 to 13 carbon atoms; and
at least one R¹ group being replaced by an R⁴ group, the R⁴ group or groups being identical to or different from one another and each representing a group of formula (R¹)ₐ(R^{f})₃₋ₐSi—R³—, where R¹, a and R^{f} have the same meaning as in the formula (I) for the POS oils A.

In one variant, the POS resin E has a content, by weight of R^{f} groups ranging from 0.1 to 10%.

The optional alkoxy-functional POS resin E is produced in the same way as the functionalized POS oil A, by condensation with an alkoxysilane. The precursor of the alkoxy-functional POS resin E is then a hydroxylated POS resin E′ corresponding to the definition given above for E except that some of the R¹ groups correspond to —OH groups. During the functionalization, the —OH groups will be replaced by R⁴ groups.

The POS resin E may also be produced by reaction of a precursor POS resin. E″ bearing ≡Si—H units on an olefinic alkoxysilane. This resin E″ corresponds to the definition given above for E except that some of the R¹ groups are now hydrogen atoms, which will be replaced by R⁴ groups during the functionalization reaction.

It is also possible to prepare an alkoxy-functional POS resin E by hydrolysis/condensation of alkyl silicates or of an alkyltrialkoxysilane. For example, in order to prepare an ethoxylated POS resin, it is possible to proceed by hydrolysis/condensation from ethyl silicate or from ethyltriethoxysilane.

To explain in a bit more detail the nature of the POS oil A, of the optional POS resin E and of the optional inert POS H, constituents of the silicone composition, it is important to specify that the R¹ groups are identical to or different from one another and are chosen from:
alkyl and haloalkyl groups having from 1 to 13 carbon atoms;
cycloalkyl and halocycloalkyl groups having from 5 to 13 carbon atoms;
alkenyl groups having from 2 to 8 carbon atoms;
monocyclic aryl and haloaryl groups having from 6 to 13 carbon atoms;
cyanoalkyl groups for which the alkyl chain members have from 2 to 3 carbon atoms; and
methyl, ethyl, propyl, isopropyl, n-hexyl, phenyl, vinyl and 3,3,3-trifluoropropyl groups being particularly preferred.

More specifically still, and non-limitingly, the R¹ groups mentioned above for the POS oil A, the optional POS resin E and the optional inert POS H, comprise:
alkyl and haloalkyl groups having from 1 to 13 carbon atoms such as methyl, ethyl, propyl, isopropyl, butyl, pentyl, hexyl, 2-ethylhexyl, octyl, decyl, 3,3,3-trifluoropropyl, 4,4,4-trifluorobutyl or 4,4,4,3,3-pentafluorobutyl groups;
cycloalkyl and halocycloalkyl groups having from 5 to 13 carbon atoms such as cyclopentyl, cyclohexyl, methylcyclohexyl, propylcyclohexyl, 2,3-difluorocyclobutyl or 3,4-difluoro-5-methyl cycloheptyl groups;
alkenyl groups having from 2 to 8 carbon atoms such as vinyl, allyl or butene-2-yl groups;
monocyclic aryl and haloaryl groups having from 6 to 13 carbon atoms such as phenyl, tolyl, xylyl, chlorophenyl, dichlorophenyl or trichlorophenyl groups;
cyanoalkyl groups to which the alkyl chain members have from 2 to 3 carbon atoms such as β-cyanoethyl and γ-cyanopropyl groups.

As concrete examples of D siloxy units (R¹)₂SiO_{2/2} present in the dialkoxypolysiloxanes A of formula (I), the precursors A′ and A″ of formulae (I′ and I″) and in the optional inert polydiorganosiloxanes H, mention may be made of: (CH₃)₂SiO, CH₃(CH₂═CH)SiO, CH₃ (C₆H₅)SiO, (C₆H₅)₂SiO, CF₃CH₂CH₂(CH₃)SiO, NC—CH₂CH₂(CH₃)SiO, NC—CH(CH₃)CH₂(CH₂═CH)SiO, NC—CH₂CH₂CH₂(C₆H₅)SiO.

It should be understood that, in the context of the present invention, it is possible to use, as precursor polymers A′ and A″ of formulae (I′ and I″), a mixture composed of several polymers which differ from one another by the value of their viscosity and/or the nature of the groups linked to the silicon atoms. It should also be indicated that the polymers A′ and A″ of formulae (I′ and I″) may optionally comprise siloxy units T of formula R¹SiO_{3/2} and/or Q siloxy units: SiO_{4/2}, in the proportion of at most 1% (this percentage expressing the number of T and Q units per 100 silicon atoms). The same comments apply to the inert polymers H.

The R¹ groups of the POS oils A, of the oils A′ and A″ and of the inert POSs H advantageously used, due to their availability in industrial products, are methyl, ethyl, propyl, isopropyl, n-hexyl, phenyl, vinyl and 3,3,3-trifluoropropyl groups. More advantageously, at least 80% by number of these groups are methyl radicals.

Precursor POS oils A′ and A″ having a dynamic viscosity at 25° C. ranging from 1000 to 1 000 000 mPa·s, and preferably ranging from 10 000 to 200 000 mPa·s, are used.

Regarding the (optional) inert POSs H, they have a dynamic viscosity at 25° C. ranging from 10 to 200 000 mPa·s, and preferably ranging from 50 to 150 000 mPa·s.

The inert POSs H, when they are used, may be introduced in their entirety or in several fractions and at several stages or in a single stage of the preparation of the composition. The optional fractions may be identical or different in terms of nature and/or proportions. Preferably, H is introduced in its entirety in a single stage.

As examples of R¹ groups, alkoxy-functional POS resins E which are suitable or which are advantageously used, mention may be made of the various R¹ groups of the type of those mentioned by name above for the alkoxy-functional POS oils A, the precursor POS oils A′ and A″ and the inert POSs H. These silicone resins E are well-known branched polyorganosiloxane polymers, the preparation processes of which are described in numerous patents. As concrete examples of resins that can be used, mention may be made of MQ, MDQ, TD and MDT resins.

Preferably, as examples of alkoxy-functional POS resins E that can optionally be used, mention may be made of the POS resins E that do not comprise, in their structure, a Q unit. More preferably, as examples of resins that can be used, mention may be made of the functionalized TD and MDT resins comprising at least 20% by weight of T units and having a content, by weight, of R^{f} groups ranging from 0.3 to 5%. More preferably still, use is made of resins of this type, in the structure of which at least 80% by number of the R¹ groups are methyl groups. The R^{f} functional groups of the optional POS resins E may be borne by the M, D and/or T units.

Regarding the alkoxy-functional POS oils A, the alkoxy-functional POS resins E and optional alkoxy-functional silanes G1, they bear R^{f} alkoxy groups of formula R²O—(CH₂CH₂O)_{b}—. Mention may be made, as concrete examples of R² groups that are particularly suitable, of the same groups as those mentioned by name above for the R¹ groups of the POS oils A, of the precursor POS oils A′ and A″ and of the inert polymers H. More particularly, R² groups which are suitable are linear or branched alkyl groups comprising from 1 to 4 carbon atoms (methyl, ethyl, propyl, methylethyl, butyl, 1-methylpropyl, 2-methylpropyl or dimethylethyl groups). Preferably, b is equal to 0 and R^{f} represents an alkoxy group chosen from ethoxy and propoxy groups. The ethoxy group is particularly preferred since, in the context of the invention, it offers the best compromise between the stability of the silicone composition and the reactivity in the presence of moisture, despite the absence of a tin-based polyaddition catalyst.

Regarding each R³ group, it represents, as has already been indicated, an oxygen atom or a divalent hydrocarbon-based group. As divalent hydrocarbon-based groups, mention will preferably be made of methylene, ethylene, propylene and butylene groups; the ethylene group is more particularly preferred.

According to one variant of the invention, each R³ symbol represents an oxygen atom. In this context, according to a preferred variant, they are derived from alkoxy-functional silane crosslinkers G1 chosen from: Si(OCH₃)₄, Si(OCH₂CH₃)₄, Si(OCH₂CH₂CH₃)₄, (CH₃O)₃SiCH₃, (C₂H₅O)₃SiCH₃, (CH₃O)₃Si (CH═CH₂), (C₂H₅O)₃Si(CH═CH₂), (CH₃O)₃Si(CH₂—CH═CH₂), (CH₃O)₃Si[CH₂—(CH₃)C═CH₂], (C₂H₅O)₃Si(OCH₃), Si(OCH₂—CH₂—OCH₃)₄, CH₃Si(OCH₂—CH₂—OCH₃)₃, (CH₂═CH)Si(OCH₂CH₂OCH₃)₃, C₆H₅Si (OCH₃)₃, C₆H₅S(OCH₂—CH₂—OCH₃)₃.

In practice, the silanes G1 bearing alkoxy groups that are especially suitable are: Si(OC₂H₅)₄, CH₃Si(OCH₃)₃, CH₃Si(OC₂H₅)₃, (C₂H₅O)₃Si(OCH₃), (CH₂═CH)Si(OCH₃)₃, (CH₂═CH)Si(OC₂H₅)₃. Preferably, the alkoxylated silanes G1 bear at least one ethoxy group: Si(OC₂H₅)₄, CH₃Si(OC₂H₅)₃, (CH₂═CH)Si(OC₂H₅)₃.

According to one notable feature of the invention, the composition may also comprise at least one functionalization catalyst F, in the presence of which the reaction of the precursors A′ and A″ (and optionally of the precursors E′ and E″) with the appropriate alkoxysilane G1 takes place, which reaction leads to the POS oil A and to the POS resin E respectively. The functionalization catalyst F is generally found in a residual amount in the composition according to the invention.

In the case where the R³ group represents an oxygen atom and where a condensation reaction takes place between the hydroxylated precursors A′ and optionally E′ and the alkoxysilane G1, this functionalization catalyst F advantageously may be chosen from the following compounds:
potassium acetate (cf. U.S. Pat. No. 3,504,051);
various mineral oxides (cf. FR-A-1 495 011);
carbamates (cf. EP-A-0 210 402);
lithium hydroxide (cf. EP-A-0 367 696); and
sodium hydroxide or potassium hydroxide (cf. EP-A-0 457 693).

In certain cases, it may be necessary to neutralize the functionalization catalyst. Thus, regarding lithium hydroxide, it is possible to use, for this purpose numerous products such as, for example:
trichloroethylphosphate;
dimethylvinylsilylacetate;
a silylphosphate of the type as described in French patent FR-B-2 410 004; and
a precipitated or fumed silica.

In the context of the present invention where the symbol R³ represents an oxygen atom, it is recommended to use, as a functionalization catalyst F: lithium hydroxide of formula LiOH or LiOH.H₂O. It may be used, for example, in solution in at least one aliphatic alcohol having 1 to 3 carbon atoms, such as, for example, methanol, ethanol, isopropanol or a mixture of these alcohols. When one (or some) alcohol(s) is (are) present in the reaction medium, the amount used lies in the interval ranging from 0.1 to 2 parts by weight, preferably from 0.2 to 1 part by weight, per 100 parts of hydroxylated precursor polymer(s) A′.

An effective amount of functionalization catalyst F is used, that is to say an amount such that the functionalization reaction rate is as high as possible, in particular by using Si(OC₂H₅)₄, CH₃Si(OCH₃)₃, CH₃Si(OC₂H₅)₃, (C₂H₅O)₃Si(OCH₃), (CH₂═CH)Si(OCH₃)₃, (CH₂═CH)Si(OC₂H₅)₃ as a functionalization agent which is none other than the alkoxy-functional silane G1. In most cases, 0.001 to 5 mol of catalyst F are used per 1 mol of silanol (≡Si—OH) groups provided, on the one hand by the precursor(s) A′ of the alkoxylated POS oil(s) A and, on the other hand, by the precursor(s) E′ of the alkoxylated POS resin(s) E. In the preferred case that makes use of lithium hydroxide, 0.005 to 0.5 mol of LiOH are used per 1 mol of silanol groups from A′ or E′.

According to another variant of the invention, each R³ symbol represents an oxygen atom derived from an alkylpolysilicate G2. It is thus possible to prepare an alkoxy-functional POS resin E by hydrolysis/condensation of alkylsilicates or of an alkyltrialkoxysilane. For example, in order to prepare an ethoxylated POS resin, it is possible to proceed by hydrolysis/condensation from ethyl silicate or from ethyltriethoxysilane.

Preferably, in the composition according to the invention, the POS oil A and the POS resin E comprise methyl R¹ groups (at least 80% of the R¹ groups), ethoxy R^{f} groups and an oxygen atom as R³ groups.

As has been indicated above, the single-component polyorganosiloxane composition comprises, besides at least one POS oil A, at least one crosslinking catalyst C in the form of a carboxylic acid and/or a carboxylic anhydride. Preferably, this is at least one branched carboxylic acid C1 and/or at least one branched carboxylic anhydride C2. Moreover, it is preferable that the carboxylic acid C1 comprises at least three carbon atoms, better still at least five carbon atoms. Similarly, it is preferable that at least one carboxylic acid from which the carboxylic anhydride C2 derives, comprises at least three carbon atoms.

In the case of a carboxylic acid anhydride C2, the crosslinking catalyst derives from two carboxylic acids, at least one of which comprises at least three carbon atoms, preferably each of the two acids comprising at least two or three carbon atoms. According to one variant, the carboxylic acid anhydride C2 is cyclic and derives from a carboxylic diacid in which the COOH carboxyl groups are separated from one another by at least 3 carbon atoms.

Thus, the crosslinking catalyst C may preferably be chosen from: 2-ethylhexanoic acid, octanoic acid, 2-ethylbutyric acid, isobutyric acid, the anhydrides derived from one or two of these carboxylic acids, acetic anhydride and mixtures thereof.

The silicone composition may also comprise a mineral filler B chosen from acid or neutral mineral fillers or mixtures thereof. The planned filler B is mineral and may be composed of products chosen from siliceous or non-siliceous substances.

The mineral filler B may be composed of products chosen from siliceous or non-siliceous substances: from siliceous substances, preferably colloidal silicas, pyrogenic, fumed or precipitated silica powders, or the amorphous silicas of diatomeous earth, ground quartz, mixtures thereof, or else from non-siliceous fillers, preferably carbon black, titanium dioxide, aluminum oxide, hydrated alumina, expanded vermiculite, unexpanded vermiculite, treated calcium carbonate, zinc oxide, mica, talc, iron oxide, barium sulfate, slaked lime, and mixtures thereof.

Regarding siliceous substances, they may act as a reinforcing or semi-reinforcing filler.

The reinforcing siliceous fillers are chosen from colloidal silicas, pyrogenic (or fumed) and precipitated silica powders or a mixture thereof.

These powders have an average particle size generally of less than 0.1 μm and a BET specific surface area greater than 50 m²/g, preferably between 100 and 350 m²/g.

The semi-reinforcing siliceous fillers such as amorphous silicas, diatomeous earths or ground quartz may also be used.

As regards the non-siliceous mineral substances, they may act as a semi-reinforcing or bulking mineral filler. Examples of these non-siliceous fillers that can be used alone or as a mixture are carbon black, titanium dioxide, aluminum oxide, hydrated alumina, expanded vermiculite, unexpanded vermiculite, calcium carbonate, zinc oxide, mica, talc, iron oxide, barium sulfate, and slaked lime. These fillers have a particle size generally of between 0.001 and 300 μm and a BET surface area of less than 100 m²/g.

In a practical but non-limiting manner, the filler used is pyrogenic silica powder; this silica is in amorphous form when aiming to obtain translucent sealants.

These fillers may be surface-modified by treatment with the various organosilicon compounds customarily used for this purpose. Thus, these organosilicon compounds may be organochlorosilanes, diorganocyclopolysiloxanes, hexaorganodisiloxanes, hexaorganodisilazanes or diorganocyclopolysilazanes (patents FR 1 126 884, FR 1 136 885, FR 1 236 505, GB 1 024 234). The treated fillers contain, in most cases, from 3 to 30% of their weight of organosilicon compounds.

The purpose of introducing fillers is to confer good mechanical and rheological properties on the elastomers that result from the curing of the compositions according to the invention. It is possible to introduce a single type of filler or mixtures of several types.

As has been mentioned, the silicone composition optionally comprises a crosslinking co-catalyst D. This crosslinking co-catalyst D is an organometallic compound in which the metal is other than tin. For example, the metal of the crosslinking co-catalyst D is chosen from zinc, titanium, aluminum, bismuth, zirconium, boron and mixtures thereof.

The crosslinking co-catalyst D may be defined in the following manner:
an organic derivative D1 of a metal M1, chosen from the group composed of monomers D1.1 of the formula:

[L]_{c}M1[(OCH₂CH₂)_{d}OR⁵]_{4-c} (II)

in which:
the symbol L represents a σ-donor ligand with or without a π participation, such as, for example, the ligands of the type of those derived from acetylacetone, from β-ketoesters, from malonic esters and from acetylimines;
c represents 0, 1, 2, 3 or 4;
M1 is a metal chosen from titanium, zirconium and mixtures thereof;
the R⁵ groups, which are identical or different, each represent a linear or branched C₁ to C₁₂ alkyl group;
d represents zero, 1 or 2;
with the conditions according to which, when the symbol d represents zero, the R⁵ alkyl group has from 2 to 12 carbon atoms, and when the symbol d represents 1 or 2, the R⁵ alkyl group has 1 to 4 carbon atoms;
   and polymers D1.2 that result from the partial hydrolysis of the monomers D1.1 of formula (II) in which the symbol c is at most equal to 3, the symbol R⁵ has the aforementioned meaning with the symbol d representing zero;
an organic derivative D2 of a metal M2, chosen from the group composed of:
   polycarboxylates D2.1 of formula:

M2(R⁶COO)ᵥ (III)
metallic alkoxides and/or chelates D2.2 of formula:

(L)ₑM2 (OR⁷)ᵥ₋ₑ (IV)

in which formulae:
the R⁶ groups, which are identical or different, each represent a linear or branched C₁ to C₂₀ alkyl group;
the symbol R⁷ has the meaning given above in the formula (V) for R⁵;
the symbol L represents a σ-donor ligand with or without a π participation, such as, for example, the ligands of the type of those derived from acetylacetone, β-ketoesters, malonic esters and acetylimines;
M2 is a metal of valence v chosen from zinc, aluminum, bismuth, boron and mixtures thereof; and
e represents a number ranging from zero to v.

Preferably, the co-catalyst D consists of the combination of at least one organic derivative D1 and of at least one organic derivative D2. Without the following being limiting, it should be considered that the following choices are particularly suitable:
as metal M1: titanium; and
as metal M2: zinc, aluminum or mixtures thereof.

As regards the optional crosslinking co-catalyst D, mention may be made, as examples of R⁵ symbols in the organic derivatives D1.1 of formula (II), of the groups: methyl, ethyl, propyl, isopropyl, butyl, isobutyl, sec-butyl, tert-butyl, hexyl, 2-ethylhexyl, octyl, decyl and dodecyl; and as examples of symbol L in the derivatives D1.1 of formula (II), of the ligand acetylacetonate.

As concrete examples of monomers D1.1 of formula (II), mention may be made of: ethyl titanate or zirconate, propyl titanate or zirconate, isopropyl titanate or zirconate, butyl titanate or zirconate, 2-ethylhexyl titanate or zirconate, octyl titanate or zirconate, decyl titanate or zirconate, dodecyl titanate or zirconate, β-methoxyethyl titanate or zirconate, β-ethoxyethyl titanate or zirconate, β-propoxyethyl titanate or zirconate, titanate or zirconate of formula M1[(OCH₂CH₂)₂OCH₃]₄/bis(isopropyl) and bis(acetyl-acetonate) titanate or zirconate, bis(butyl) and bis(acetylacetonate) titanate or zirconate. The metallic monomer compounds D1.1 more particularly valued are the following products taken alone or as a mixture: ethyl titanate, propyl titanate, isopropyl titanate and butyl (n-butyl) titanate.

As concrete examples of polymers D1.2 originating from the partial hydrolysis of the monomers D1.1, the following may be mentioned: the polymers D1.2 originating from the partial hydrolysis of isopropyl, butyl or 2-ethylhexyl titanates or zirconates.

As regards again the curing catalyst D, mention may be made, as examples of symbols R⁶ and R⁷ in the derivatives D2.1 and D2.2 of formulae (III) and (IV) of the propyl, isopropyl, butyl (n-butyl), isobutyl, sec-butyl, tert-butyl, hexyl, 2-ethylhexyl, octyl, decyl and dodecyl groups; and as examples of symbol L in the derivatives D2.2 of formula (IV), of the acetylacetonate ligand.

As concrete examples of organic derivatives D2 mention may be made of: zinc dioctoate, tributyl borate, bismuth carboxylate and aluminum acetylacetonate. The compounds D2 more particularly valued are the following products, taken alone or as a mixture: zinc dioctoate, aluminum acetylacetonate, aluminum butoxide (linear or branched).

In particular, the crosslinking co-catalyst D is chosen from: tetrabutyltitanate, zinc bis(2-ethylhexanoate), zinc bis(octoate), aluminum acetylacetonate, tributyl borate, bismuth carboxylate, tetrapropyl zirconate, and mixtures thereof.

The single-component silicone compositions according to the present invention may also contain one or more auxiliary agent(s) I such as, in particular, per 100 parts by weight of POS oil A:
optionally from 0.1 to 10 parts of an adhesion agent I1; and
optionally an effective amount of at least one compound taken from the group formed by: antifungal agents I2; bactericides I3; inert organic diluents I4 (such as, in particular: high boiling point oil cuts, toluene, xylene, heptane, white spirit, trichloroethylene, tetrachloro-ethylene); plasticizers I5, belonging for example, to the group of alkylbenzenes having a molecular weight of above 200 g/mol comprising a branched or unbranched alkyl residue having from 10 to 30 carbon atoms; thixotropic agents I6; stabilizers I7 (such as, in particular: an iron or cerium organic acid salt, for example, iron or cerium octoate; a cerium oxide, a cerium hydroxide, an iron oxide, the oxide CaO, the oxide MgO); colored pigments I8.

The presence of an adhesion agent is not completely necessary. When one is used, the adhesion agent I1 is preferably chosen from the organosilicon compounds bearing both (1) hydrolysable groups bonded to the silicon atom and (2) organic groups substituted by groups chosen from the groups of isocyanate, epoxy, alkenyl, isocyanurate and (meth)acrylate.

By way of illustration of adhesion agents I1, mention may be made of the organosilicon compounds defined below:

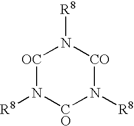

where R⁸=—CH₂)₃—Si(OCH₃)₃;
3-glycidoxypropyltrimethoxysilane (GLYMO);
vinyltrimethoxysilane (VTMS);
methacryloxypropyltrimethoxysilane (MEMO);
and mixtures thereof.

According to the invention, the single-component silicone composition comprises:
from 1 to 50% by weight, preferably from 3 to 25% by weight, of mineral filler B;
from 0.01 to 5% by weight, preferably from 0.1 to 2% by weight, of crosslinking catalyst C;
from 0 to 5% by weight, preferably from 0.1 to 2% by weight, of crosslinking co-catalyst D;

from 0 to 30% by weight, preferably from 5 to 15% by weight, of resin E;
from 0 to 1% by weight, preferably from 0 to 0.1% by weight, of functionalization catalyst F;
from 0 to 10% by weight, from 0 to 5% by weight, of alkoxy-functional silane and/or of alkylpolysilicate G;
from 0 to 30% by weight, preferably from 5 to 20% by weight, of inert polydiorganosiloxane H;
from 0 to 20 parts by weight of auxiliary agent(s) I; and
the balance to 100% by weight of POS oil A, on condition that the POS oil A represents at least 45% by weight, preferably at least 55% by weight, of the composition.

Particularly preferably, when a co-catalyst D is present, the D/C molar ratio is between 1/1 and 4/1 in moles of metal of the co-catalyst D per moles of catalyst C.

The compositions according to the invention cure at ambient temperature, especially at temperatures between 5 and 35° C., in the presence of moisture. The curing (or the crosslinking) takes place from the outside to the inside of the bulk of the composition. A skin is first formed at the surface then the crosslinking continues inside the bulk. The skin-over time is faster in the presence of a crosslinking catalyst of branched carboxylic acid type than in the presence solely of an organometallic co-catalyst.

These compositions may be used for multiple applications such as sealing in the building industry, joining and bonding of the most diverse materials (metals; plastics such as, for example, PVC, or PMMA; natural and synthetic rubbers; wood; cardboard; earthenware; brick; glass; stone; concrete; masonry components), both in the context of the building industry and in that of the automobile, electrical goods and electronics industries.

According to another of its aspects, another subject of the present invention (second subject of the invention) is a tin-free elastomer capable of adhering to various substrates and obtained by crosslinking and curing of the single-component silicone composition described above.

The tin-free single-component silicone compositions according to the present invention are prepared in the absence of moisture by operating in a sealed reactor, equipped with stirring, in which it is possible, if necessary, to draw a vacuum, then to optionally replace the evacuated air with an anhydrous gas, for example, with nitrogen.

For this preparation it is recommended to use a device that operates in batch mode, or in continuous mode, which makes it possible:
to intimately mix, in the absence of moisture:
   in step 1, the following constituents: POS oil A′ or A″ precursor of the alkoxy-functional POS oil A, resin E′ or E″ (optional) precursor of the alkoxy-functional POS resin E, optionally olefinic alkoxysilane (which may be the silane G1), and/or alkylpolysilicate G2, functionalization catalyst F, inert POS H (optional);
   then in step 2, the reaction mixture from step 1, supplemented by the addition of the constituents B (optional), C, I (optional), H (optional) and D (optional); and
evacuating the volatile substances present (low molecular weight polymers, alcohol formed during the functionalization reaction) at various moments in the operation of the process:
   during the aforementioned step 1; and/or
   during the aforementioned step 2; and/or
   in a final step 3.

There are, of course, for carrying out this preparation process, other possible orders of introducing the constituents. For example, the following introduction order could be used:
step 1: A′+optionally E′+G+F optionally D+B, with evacuation at this stage of the volatile substances; and
step 2: C+G+optionally I+optionally D+D.

As examples of devices, mention may be made of: slow dispersers; paddle, shaft, arm or anchor mixers; planetary mixers, hook mixers or single-screw or multi-screw extruders.

Each of the steps implemented in this preparation is carried out at a temperature that lies in the temperature interval ranging from 10 to 110° C. Preferably, each of the steps is carried out at a temperature ranging from 15 to 90° C.

Step 1 is carried out for a sufficient period of time (ranging for example from 10 seconds to 10 minutes) in order to achieve a functionalization reaction that is complete or as close as possible to the maximum degree of functionalization attainable under the chosen operating conditions.

Step 2 is carried out for a sufficient period of time (ranging for example from 10 seconds to 30 minutes) in order to obtain homogenous compositions.

Step 3 is generally carried out under a reduced pressure between 20×10² Pa and 900×10² Pa, for a sufficient period of time (ranging for example from 10 seconds to 1 hour) in order to evacuate all the volatile substances.

The invention will be better understood with the aid of the following examples that describe the preparation of alkoxy type single-component compositions that result in crosslinked elastomers that do or do not have good usage properties, depending on whether they correspond or not to the present invention.

### EXAMPLES

### Preparation 1: Synthesis of a Non-Catalyzed Base (Paste)

464 g of alpha, omega-dihydroxylated polydimethyl-siloxane oil A′ having a viscosity of around 80 000 mPa·s and 19.25 g of vinyltriethoxysilane (VTEO) crosslinker G1 were charged to the chamber of a “butterfly” uniaxial mixer under cooling. The whole assembly was mixed for 2 minutes at 200 rpm. Then the functionalization catalyst F, namely, 2 g of 3 wt % ethanolic potassium hydroxide, was introduced. The functionalization reaction was left to take place for 5 minutes with stirring (400 rpm). Then 31 g of treated pyrogenic silica (R104 from Degussa) B having a specific surface area of 150 to 200 m²/g were incorporated at a moderate stirring rate (1 min at 160 rpm) then more rapidly (4 min at 400 rpm) in order to complete the dispersion thereof in the mixture. A relatively thick and not very runny viscoelastic fluid was obtained. The paste obtained was degassed under vacuum (less than 50 mbar for 6 min at 130 rpm) then transferred into an airtight container for storage.

### Preparation 2: Addition of Catalyst to the Paste

In order to obtain an elastomer that crosslinks in the presence of atmospheric moisture, a condensation catalyst C and optionally a crosslinking co-catalyst D were added to the paste obtained according to preparation 1. In order to compare the various catalysts 0.7 g of catalyst was added to 49.3 g of paste using a rapid mixer of the Speed-mixer type sold by Hauschild (2 times 20 s at 2000 rpm).

The various catalysts C were 2-ethylhexanoic acid, octanoic acid, 2-ethylbutyric acid, isobutyric acid and acetic anhydride. The various co-catalysts D were butyl titanate and zinc bis(2-ethylhexanoate). Various mixtures of catalyst C and of co-catalyst D were also tested:
mixture of butyl titanate and of 2-ethylhexanoic acid in a 1/1 molar ratio;
mixture of butyl titanate and of 2-ethylhexanoic acid in a 2/1 molar ratio;
mixture of butyl titanate and of 2-ethylhexanoic acid in a 1/2 molar ratio;
mixture of butyl titanate and of 2-ethylbutyric acid in a 2/1 molar ratio;
mixture of butyl titanate and of isobutyric acid in a 2/1 molar ratio;
mixture of butyl titanate and of octanoic acid in a 2/1 molar ratio;
mixture of butyl titanate and of acetic anhydride in a 2/1 molar ratio.

### Preparation 3: Synthesis of a Non-Catalyzed Base (Paste)

1113 g of alpha, omega-dihydroxylated polydimethyl-siloxane oil A′ having a viscosity of around 50 000 mPa·s and 46.20 g of vinyltrimethoxysilane (VTEO) crosslinker G1 were charged to the chamber of a “butterfly” uniaxial mixer under cooling. The whole assembly is mixed for 2 minutes at 200 rpm. Then the functionalization catalyst F, namely, 4.8 g of lithium monohydrate at 4 wt % in methanol, was introduced. The functionalization reaction was left to take place for minutes with stirring at 400 rpm. Then 36 g of pyrogenic silica (Aerosil 150 from Degussa) B having a specific surface area of 150 m²/g were incorporated at a moderate stirring rate (10 min at 160 rpm) then more rapidly (4 min at 400 rpm) in order to complete the dispersion thereof in the mixture. A relatively thick and not very runny viscoelastic fluid was obtained. The paste obtained was degassed under vacuum (less than 50 mbar for 6 min at 130 rpm) then transferred into a container for storage.

### Preparation 4: Addition of Catalyst to the Paste

In order to obtain an elastomer that crosslinks with atmospheric moisture, it was necessary to add a condensation catalyst C and co-catalyst D to the paste obtained according to preparation 3. In order to compare a catalyst and a co-catalyst according to the invention with a commercial catalyst solely based on an organic titanium compound, 3.8 mmol of titanium catalyst were introduced per 100 g of paste using a rapid mixer (2 times 20 sec at 2000 rpm).

The various catalysts were:
mixture of butyl titanate and 2-ethylhexanoic acid in a 2/1 molar ratio (conforming to the invention) and
titanium tetrakis(2-ethylhexanolate) (filed under the name Tyzor TOT from DuPont) (commercial catalyst).

### Characterization

The catalytic activities and the reactivity of each composition were evaluated from the change in the Shore A hardness over time of 2 mm-thick films that crosslink under controlled conditions for an increasing duration. Before carrying out the hardness measurement, the film was cut and stacked as three layers under the durometer. The controlled temperature and hygrometry conditions were the following:
temperature: 23±2° C.; and
hygrometry: 50±5%.

The results are given in the tables below. Examples 1 to 6 use the paste prepared according to preparation 2. Examples 7 and 8 use the paste prepared according to preparation 4.

### Example 1

### Catalysis with Butyl Titanate (Control)

It was observed that the elastomer set very slowly with butyl titanate.

### Example 2

### Catalysis with C8 Carboxylic Acids

When butyl titanate was substituted by a C8 carboxylic acid the setting kinetics were faster, especially when the carboxylic acid was branched, as 2-ethylhexanoic acid is.

### Example 3

### Catalysis Using Butyl Titanate 2-Ethylhexanoic Acid Synergy

The combination of butyl titanate with 2-ethylhexanoic acid made it possible to have crosslinking kinetics that were faster than the two constituents taken separately.

The proportion of the two constituents in the mixture plays a role. Of the three proportions studied, the molar ratio of 2 mol of butyl titanate per 1 mol of 2-ethylhexanoic acid was the one that gave the fastest setting kinetics.

### Example 4

### Catalysis Using Butyl Titanate—Branched Butyric Acid Synergy

It is possible to use branched butyric acids (2-ethylbutyric and isobutyric acids) in substitution for the 2-ethylhexanoic acid with butyl titanate in the same proportions and to obtain a similar catalytic effect.

### Example 5

### Catalysis Using Butyl Titanate—Octanoic Acid Synergy

In the synergy between butyl titanate and octanoic acid the lower reactivity of octanoic acid with respect to 2-ethylhexanoic acid was found.

### Example 6

### Catalysis Using Butyl Titanate—Acetic Anhydride Synergy

It was possible to use acid anhydrides such as acetic anhydride with butyl titanate and to obtain setting of the elastomer at the end of one day.

### Example 7

### Catalysis Using Butyl Titanate—2-Ethylhexanoic Acid Synergy

This test showed that the setting kinetics seen with respect to the hardness was faster with the butyl titanate—2-ethylhexanoic acid mixture than the titanium tetrakis(2-ethylhexanolate).

### Example 8

### Catalysis with Titanium Tetrakis (2-Ethylhexanolate)

It was observed that the elastomer set very slowly with titanium tetrakis(2-ethylhexanolate).

| | Catalyst and co- | Shore A hardness after n days (D) | | | |
|---|---|---|---|---|---|
| Example | catalyst | 1 D | 2 D | 5 D | 7 D |
| 1 | Butyl titanate | gel | 3 | 13 | 16 |
| 2 | 2-ethylhexanoic | 10 | 17 | 17 | 17 |
| | acid | | | | |
| 2 | Octanoic acid | 6 | 16 | 19 | 19 |
| 3 | Butyl titanate | 12 | 19 | 22 | 22 |
| | 2-ethylhexanoic | | | | |
| | acid | | | | |
| | (2 + 1) moles | | | | |
| 5 | Butyl titanate | 6 | 16 | 21 | 22 |
| | Octanoic acid | | | | |
| | (2 + 1) moles | | | | |

| | Catalyst and co- | Shore A hardness after n days (D) | | | |
|---|---|---|---|---|---|
| Example | catalyst | 1 D | 2 D | 3 D | 7 D |
| 1 | Butyl titanate | 1 | 8 | 13 | 17 |
| 3 | Butyl titanate | 12 | 18 | 19 | 20 |
| | 2-ethylhexanoic | | | | |
| | acid | | | | |
| | (1 + 1) moles | | | | |
| 3 | Butyl titanate | 14 | 19 | 21 | 21 |
| | 2-ethylhexanoic | | | | |
| | acid | | | | |
| | (2 + 1) moles | | | | |
| 3 | Butyl titanate | 3 | 12 | 17 | 18 |
| | 2-ethylhexanoic | | | | |
| | acid | | | | |
| | (1 + 2) moles | | | | |
| 4 | Butyl titanate | 14 | 20 | 21 | 21 |
| | 2-ethylbutyric | | | | |
| | acid | | | | |
| | (2 + 1) moles | | | | |
| 4 | Butyl titanate | 15 | 20 | 21 | 21 |
| | isobutyric acid | | | | |
| | (2 + 1) moles | | | | |
| 5 | Butyl titanate | 9 | 15 | 20 | 21 |
| | Octanoic acid | | | | |
| | (2 + 1) moles | | | | |
| 6 | Butyl titanate | 7 | 14 | 18 | 20 |
| | Acetic anhydride | | | | |
| | (2 + 1) moles | | | | |

| | | Shore A hardness | | |
|---|---|---|---|---|
| | Catalyst and co- | after n days (D) | | |
| Example | catalyst | 1 D | 2 D | 7 D |
| 7 | Butyl titanate | 9 | 17 | 18 |
| | 2-ethylhexanoic acid | | | |
| | (2 + 1) moles | | | |
| 8 | Titanium tetrakis (2- | 1 | 9 | 15 |
| | ethylhexanolate) | | | |

1.-20. (canceled)

21. A tin-free, single-component silicone composition that is storage-stable in the absence of moisture and that is crosslinkable by polycondensation, in the presence of water, into an elastomer, said composition comprising:
at least one crosslinkable alkoxy-functional polyorganosiloxane oil A;
as a crosslinking catalyst C, at least one carboxylic acid and/or at least one carboxylic anhydride;
and none, one or more of the following optional components:
at least one mineral filler B;
as crosslinking co-catalyst D, at least one organometallic compound in which the metal is other than tin;
at least one crosslinkable alkoxy-functional polyorganosiloxane resin E;
a residual amount of a functionalization catalyst F employed during the preparation of the oil A and/or the resin E;
at least one alkoxy-functional silane and/or at least one alkylpolysilicate G;
at least one polydiorganosiloxane H that is inert with respect to the polycondensation reaction; and
at least one auxiliary agent I.

22. The tin-free, single-component silicone composition as defined by claim 21, in which the oil A comprises a linear silicone oil having the following general formula (I): 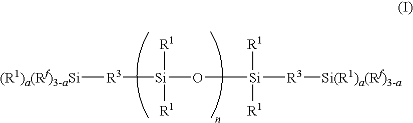
or a substantially linear silicone oil of general formula (I) in which siloxy units D of formula (R¹)₂SiO_{2/2} are replaced by siloxy units T of formula R¹SiO_{3/2} and/or siloxy units Q of formula SiO_{4/2}, the number of T and Q siloxy units being less than or equal to 1 per 100 silicon atoms, wherein:
the R¹ radicals, which may be identical or different, are each a saturated or unsaturated, substituted or unsubstituted, aliphatic, cyclanic or aromatic monovalent hydrocarbon-based radical having from 1 to 13 carbon atoms;
the R^{f} radicals, which may be identical or different, are each an alkoxy group of formula R²O—(CH₂CH₂O)_{b}— in which the R² radicals, which may be identical or different, are each a linear or branched alkyl radical having from 1 to 8 carbon atoms, or a cycloalkyl radical having from 3 to 8 carbon atoms, and in which b is equal to 0 or 1;
the R³ groups, which may be identical or different, are each an oxygen atom or an aliphatic saturated divalent hydrocarbon-based radical having from 1 to 4 carbon atoms;
the value n is sufficient to provide the POS oil A a dynamic viscosity at 25° C. that ranges from 10³ mPa·s to 10⁶ mPa·s; and
a is equal to 0 or 1.

23. The tin-free, single-component silicone composition as defined by claim 22, in which:
the R¹ radicals, which may be identical or different, are each an alkyl or haloalkyl radical having from 1 to 13 carbon atoms, a cycloalkyl or halocycloalkyl radical having from 5 to 13 carbon atoms, an alkenyl radical having from 2 to 8 carbon atoms, a monocyclic aryl or haloaryl radical having from 6 to 13 carbon atoms, or an cyanoalkyl radical in which the alkyl moiety has from 2 to 3 carbon atoms;
the R² radicals, which may be identical or different, are each a linear or branched alkyl radical having from 1 to 4 carbon atoms; and
the R³ groups, which may be identical or different, are each an oxygen atom or a methylene, ethylene, propylene or butylene radical.

24. The tin-free, single-component silicone composition as defined by claim 22, in which:
the R¹ radicals, which may be identical or different, are each a methyl, ethyl, propyl, isopropyl, n-hexyl, phenyl, vinyl or 3,3,3-trifluoropropyl radical;
the R^{f} radicals, which may be identical or different, are each an ethoxy or propoxy radical; and
the R³ groups, which may be identical or different, are an oxygen atom or a methylene, ethylene, propylene or butylene radical.

25. The tin-free, single-component silicone composition as defined by claim 22, in which the R¹ radicals are methyl radicals, the R^{f} radicals are ethoxy radicals and the R³ groups are oxygen atoms.

26. The tin-free, single-component silicone composition as defined by claim 21, comprising a mineral filler B selected from among an acid mineral filler or a neutral mineral filler, or a mixture of acid and/or neutral fillers.

27. The tin-free, single-component silicone composition as defined by claim 21, comprising a mineral filler B selected from among siliceous substances, colloidal silicas, pyrogenic, fumed or precipitated silica powders, or amorphous silicas of diatomeous earth, ground quartz, mixtures thereof, or from non-siliceous fillers, carbon black, titanium dioxide, aluminum oxide, hydrated alumina, expanded vermiculite, unexpanded vermiculite, treated calcium carbonate, zinc oxide, mica, talc, iron oxide, barium sulfate, slaked lime, and mixtures thereof.

28. The tin-free, single-component silicone composition as defined by claim 21, comprising a mineral filler B selected from among pyrogenic silica powders, optionally surface-modified by treatment with at least one organosilicon compound.

29. The tin-free, single-component silicone composition as defined by claim 21, in which the crosslinking catalyst C comprises at least one branched carboxylic acid C1 and/or at least one branched carboxylic anhydride C2.

30. The tin-free, single-component silicone composition as defined by claim 21, in which the crosslinking catalyst C is such that:
in the case of a carboxylic acid C1, it comprises at least three carbon atoms; and
in the case of a carboxylic anhydride C2, it derives from two carboxylic acids that each comprise at least three carbon atoms, or derives from a carboxylic diacid in which the —COOH carboxyl groups are separated from one another by at least 3 carbon atoms.

31. The tin-free, single-component silicone composition as defined by claim 21, in which the crosslinking catalyst C is selected from among 2-ethylhexanoic acid, octanoic acid, 2-ethylbutyric acid, isobutyric acid, the anhydrides obtained from these carboxylic acids, acetic anhydride and mixtures thereof.

32. The tin-free, single-component silicone composition as defined by claim 21, comprising a crosslinking co-catalyst D, the metal thereof being selected from among zinc, titanium, aluminum, bismuth, zirconium, boron and mixtures thereof.

33. The tin-free, single-component silicone composition as defined by claim 32, wherein the crosslinking co-catalyst D is selected from among tetrabutyl titanate, zinc bis(2-ethylhexanoate), zinc bis(octoate), aluminum acetylacetonate, tributyl borate, bismuth carboxylate, tetrapropyl zirconate, and mixtures thereof.

34. The tin-free, single-component silicone composition as defined by claim 21, having a molar ratio DC ranging from 1/1 and 4/1 in moles of metal of the co-catalyst D per moles of catalyst in C.

35. The tin-free, single-component silicone composition as defined by claim 21 comprising a POS resin E having at least two different siloxy units selected from among the siloxy units M of formula (R¹)₃SiO_{1/2}, the siloxy units D of formula (R¹)₂SiO_{2/2}, the siloxy units T of formula R¹SiO_{3/2} and the siloxy units Q of formula SiO_{4/2}, at least one of these siloxy units being a T or Q unit, wherein:
the R¹ radicals, which may be identical or different, are each a saturated or unsaturated, substituted or unsubstituted, aliphatic, cyclanic or aromatic monovalent hydrocarbon-based radical having from 1 to 13 carbon atoms; and
at least one R¹ radical being replaced by an R^{f} radical, the R^{f} radicals, which may be identical or different, are each an alkoxy radical of formula R²O—(CH₂CH₂O)_{b}—, in which the R² radicals, which may be identical or different, are each a linear or branched alkyl radical having from 1 to 8 carbon atoms, or a cycloalkyl radical having from 3 to 8 carbon atoms, and in which b is equal to 0 or 1.

36. The tin-free, single-component silicone composition as defined by claim 35, in which said resin E has a content, by weight of R^{f} radicals ranging from 0.1 to 10%.

37. The tin-free, single-component silicone composition as defined by claim 21, comprising:
from 1 to 50% by weight of mineral filler B;
from 0.01 to 5% by weight of crosslinking catalyst C;
from 0 to 5% by weight of crosslinking co-catalyst D;
from 0 to 30% by weight of resin E;
from 0 to 1% by weight of functionalization catalyst F;
from 0 to 10% by weight of alkoxy-functional silane and/or of alkylpolysilicate G;
from 0 to 30% by weight of inert polydiorganosiloxane H;
from 0 to 20 parts by weight of auxiliary agent(s) I; and
the balance to 100% by weight of oil A, with the proviso that the oil A constitutes at least 45% by weight of the composition.

38. The tin-free, single-component silicone composition as defined by claim 21, in which said POS oil A, and optionally said POS resin E, are prepared by:
condensation from the ≡Si—OH units of a hydroxylated polyorganosiloxane A′ or E′, precursor of an alkoxy-functional polyorganosiloxane A or E, and an alkoxy radical of an alkoxysilane, in the presence of a functionalization catalyst F; or
addition from the ≡Si—H units of a hydrogenated polyorganosiloxane A″ or E″, precursor of an alkoxy-functional polyorganosiloxane A or E, and an olefin group of an olefinic alkoxysilane; or
addition from the unsaturated organic units of a polyorganosiloxane A″ or E″, precursor of an alkoxy-functional polyorganosiloxane A or E, and a hydrogen group of a hydrogenalkoxysilane.

39. The tin-free, single-component silicone composition as defined by claim 38, in which said oil A is prepared by functionalization of an am-dihydroxylated polydimethylsiloxane oil A′ with an ethoxylated silane, in the presence of a functionalization catalyst F.

40. A tin-free silicone elastomer obtained by crosslinking and curing of a single-component polyorganosiloxane composition as defined by claim 21.
